(19) United States
(12) Patent Application Publication
(10) Pub. No.: US 2002/0003199 A1
(43) Pub. Date: Jan. 10, 2002

(54) Core for injection molding tools

(76) Inventors: John M. Check, Williamsburg, MI (US); Cletis Jackson, Mason, OH (US)

Correspondence Address: John C. Evans, Reising, Ethington, Barnes, Kisselle,, Learman & McCulloch, PC, P O Box 4390, Troy, MI, 48099, US

(21) Appl. No.: 09/731,217

(22) Filed: Dec. 6, 2000

Related U.S. Application Data
(60) Provisional application No. 60/169,165, filed on Dec. 6, 1999.

(51) Int. Cl. B29C 33/04

(52) U.S. Cl. 249/79; 425/552; 425/526; 228/119

(57) ABSTRACT

A core for molding apparatus includes inner surface configurations for improving the cooling of injected plastic material.

### TECHNICAL FIELD

This is a utility application based upon provisional U.S. Application No. 60/169,165 filed Dec. 6, 2000.

This invention relates to molding apparatus and more particularly to molding apparatus having water-cooled core and cavity assemblies that cooperate to form hollow molded parts. The apparatus is an improvement on the molding apparatus shown in U.S. Pat. No. 5,498,150 issued to me on Mar. 12, 1996 and incorporated herein by reference.

### BACKGROUND OF THE INVENTION

To decrease cycle time and to insure good molding of either metal casting or injection molded plastic parts, it is advantageous to provide coolant flow passages within a mold apparatus. When cooling fluid is passed through such passages during the molding process, it removes heat from the apparatus. Where a molding apparatus includes a mold cavity part that has a plurality of female cavities formed within it, and where those female cavities are configured to receive core parts that cooperate with the female cavities to form the surfaces of a molded part, apparatus for cooling has included a round cooling tube that is formed by the interior surface of the core part.

An example of such cooling apparatus is set forth in U.S. Pat. No. 4,655,280.

One problem with such arrangements is that molded parts having an elongated configuration must be formed, in part, by a core that has a length to width ratio large enough to allow the core to deflect when impacted by material that is injected against the core under high pressure conditions. Since many materials are best shaped and densified under such high-pressure conditions, one problem with prior art apparatus is how to provide a low cost, elongated core that will not deflect or warp under high temperature and high-pressure operation.

Another problem with such molding apparatus is that the coolant flow is restricted to an annular surface in such a way as to limit the removal of heat from each of the mold cavities.

U.S. Pat. No. 5,498,150 issued to me on Mar. 12, 1996 addresses these problems by disclosing a mold assembly having a mold part that forms the outer wall of a molded part. The mold part has a plurality of elongated cavities within it. A fluid cooled core is inserted within each of the elongated cavities before injecting material into the mold assembly. Each fluid cooled core has an outer surface that forms an inner wall of a tubular portion of the molded part. Each fluid cooled core includes a plurality of circumferentially spaced, longitudinal ribs or fins that extend integrally and radially inward from around an inner circumferential surface of the core. The ribs reinforce each fluid cooled core radially inwardly of their respective elongated cavities and along the length of each fluid cooled core. The cooling channels defined therein increase the surface area or wetting area of the mold assembly so as to increase the cooling efficiency. This construction controls core deflection that results from high-pressure injection of a material to be molded. A separate fluid inlet pipe is disposed coaxially within each core and is radially spaced from the inner circumferential surface of each core. An outer end of each fluid inlet pipe is adapted to be connected to a source of coolant and an inner end is in communication with a plurality of circumferentially spaced passages defined by the ribs within each core. Each of these passages returns the flow of cooling fluid to an elongated annular passage that extends along the length of the core between the fluid inlet pipe and the inner surface. Radially inner edges of the ribs are configured to slidably receive an inner length of the fluid inlet pipe during core assembly.

After assembly, each fluid inlet pipe lies in contact with or in close proximity to the rib inner edges. While this design is more resistant to warping and deformation during injection than prior art assemblies, the fluid inlet pipe still has some freedom to rotate, flex, warp and otherwise deform under the force of pressurized injections of molten material during molding. In addition, while the temperature of the core can be controlled using the fluid cooling system, the cavity portion of the mold cannot.

In my copending U.S. patent application Ser. No. 09/153,956 filed Sep. 16, 1998, incorporated herein by reference a further improvement is provided that defines a fluid cooled core that is stronger, more rigid and therefore more resistant to deflection and warping under high temperature and high-pressure operation and a configuration that is able to cool both inner and outer walls of a tubular portion of a molded part. A mold assembly is provided that includes spaced, moveable mold parts, one mold part including a hollow cavity having a cavity inner surface configured to form an outer wall of an elongated, generally annular molded part and the other mold part including a corresponding core element having a core outer surface configured to form an inner wall of the molded part. The core element is at least partially disposed within the cavity and the core outer surface is spaced from the cavity inner surface defining a generally annular mold chamber for receiving molten material to be molded to the shape of the molded part. The core element has an open end and a closed end that defines a hemispherical portion of the core outer surface. The shape of the closed end can vary according to the application and could be flat. The core element further includes a generally tubular core inner surface and a plurality of circumferentially spaced longitudinal ribs that integrally extend radially inward from the core inner surface. The ribs define a plurality of elongated coolant passages. The core element is at least partially disposed within the cavity and the core outer surface is spaced from the cavity inner surface defining a generally annular mold chamber for receiving molten material to be molded to the shape of the molded part. The core element further includes a first portion of a high strength material defining generally tubular core inner surface and a plurality of circumferentially spaced longitudinal ribs that integrally extend radially inward from the core inner surface through part of the length of the core element. The ribs define a plurality of elongated coolant passages that receive return coolant flow from an annular space formed between a second reduced diameter hollow tip portion of the core element formed by a high heat transfer material that can be impact resistant; a fluid inlet pipe is coaxially disposed within the core element. The fluid inlet pipe has an outer surface spaced from the core inner surface, one end of the fluid inlet pipe configured to connect to a source of coolant and a second end of the pipe being in fluid communication with the plurality of coolant passages.

In my copending Application 90/526,626 filed Mar. 16,2000 a core element and fluid inlet pipe are integrally connected together to further reinforce the core element radially inwardly of the mold chamber and along the length of the core element against core deflection that results from high pressure injection of a material to be molded while providing increased cooling efficiency. This design is more resistant to warping and deformation during injection than prior art designs. The arrangement further comprises the use of bimetal materials in the core body so that a first lower portion can be formed of relatively high strength lower heat transfer material such as stainless steel and the molding surface on the core body can be formed of a high strength alloy composite material such as a nickel copper tungsten material that will resist impact damage and that will provide increased thermal diffusivity and increased thermal conductivity at an inlet opening for flow of molten material into the mold cavity formed between the hollow mold part and the core part. The fluid inlet pipe is a single element that can be assembled axially within preformed first and second portions of differing heat transfer characteristics. Furthermore, the first and second portions can be connected by suitable bonding techniques so that the preexisting core elements of the type shown in copending United States Patent Application can be can be upgraded to have improved heat transfer characteristics by a method that includes the steps of cutting the end of a core end with integral fluid inlet pipe and replacing the inlet pipe with a inlet pipe extending from the first portion of the preexisting core; providing a hollow tip of higher thermal conductivity than the first portion and placing it over the heat pipe extension and thereafter bonding an end of the hollow tip to the cutoff end of the first portion by suitable techniques including but not limited to diffusion bonding.

### INVENTION SUMMARY

In one embodiment a core is provided as a solid metal tip of high thermal conductivity material. In another embodiment a core is configured to have a shaped inner wall suitable for forming a preform for a non-round plastic bottle.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is an exploded sectional view of the first embodiment prior to assembly;

FIG. 2 is a sectional view of the embodiment in FIG. 1 following assembly;

FIG. 3 is a sectional view of another embodiment;

FIG. 4 is an enlarged fragmentary sectional view of a part of the embodiment in FIG. 3; and

FIG. 5 is a sectional view of a non-round bottle formed by the embodiment in FIGS. 3 and 4.

### PREFERRED EMBODIMENT DESCRIPTION

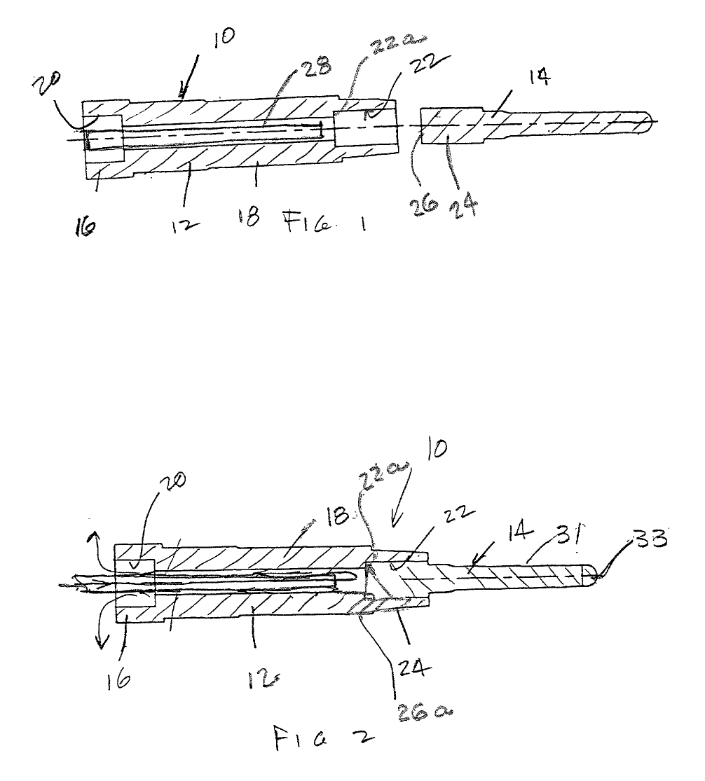

An integral bubbler type water-cooled core element or core assembly 10 is shown in FIG. 1 as having a core support member 12, and a core part 14. The support member 12 is configured to be supported within a known mold apparatus of the type shown in U.S. Pat. No. 5,498,150 issued to me on Mar. 12, 1996. Such apparatus includes separable mold parts one of which carries the core support member and includes cooling passages for connection to an inlet segment 16. An extension segment 18 locates the core 14 within a mold part cavity that will receive plastic or other material to be cooled by fluid flow through the interior of the member 12.

More particularly, the member 12 has a bore 20 at one end thereof adapted to be connected to a coolant source. The member 12 includes a bore 22 at the opposite end for supporting the core 14. The core 14 is configured as a solid metal piece of high heat conductivity material and includes a large diameter end 24 thereon with a flat planar end surface 26. The large diameter end 24 is adapted to be bonded to the member 12 at surfaces there between including but not limited to at a tubular annular planar surface 22a within the bore 22 and at a flat planar end surface portion 26a.

The member 12 has a elongated tube 28 therein through which coolant is directed to flow against a flat end surface 26 of the core 14 at the bore 22. The bonded configuration prevents fluid leakage of the coolant and furthermore precisely locates the solid metal core 14 so as to precisely center a tapered cylindrical outer surface 31 and a hemispherical end 33 within a mold cavity that with the core defines the shape of a part to be molded. The mold apparatus is of the type shown in the '150 patent including a cavity in the mold apparatus. In the present example the outer surface 31 can be configured to define a hollow preform suitable for blowing molding a bottle. The shape of the outer surface of the core 14 thus depends on the shape of the part to be injection molded about the core. In some cases the portions surface 31 can be almost the same diameter with a small taper when, for example, the part being formed is a preform for hollow cylinder disposable syringes. In the illustrated embodiment, the solid core 14 is formed of a high heat transfer material such as Copper, Aluminum, Tungsten Carbide Cobalt, Silicon Carbide, Beryllium Cooper but is preferably formed of a high impact resistance material that does not have materials therein that are incompatible with applications for molding medical parts or the like. One example of such material is an alloy of nickel copper and tungsten.

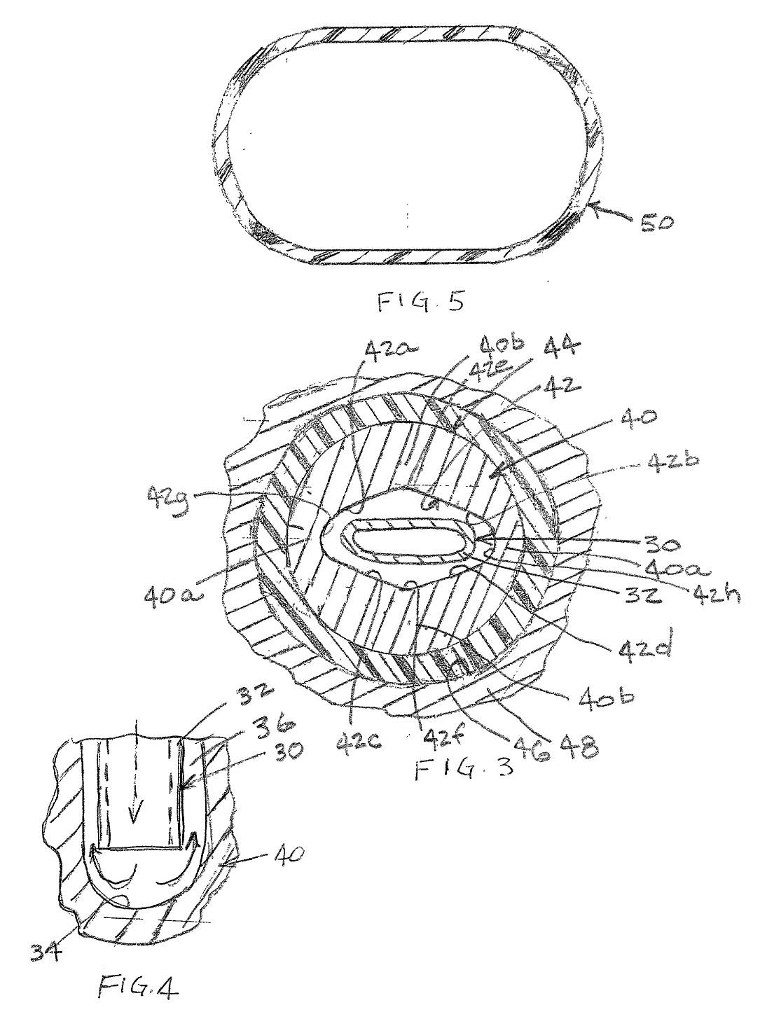

The embodiment shown in FIG. 3 includes a bubbler 30 comprising tube 32 for supplying coolant from a inlet of the type shown in my earlier patent and provisional applications as referenced herein. The bubbler 30 directs coolant against a return surface 34 shown in FIG. 4 and into a coolant return passage 36 formed between the bubbler 30 and a core member 40. As best seen in FIG. 3, the core member 40 has an irregular inner surface 42 and a cylindrical outer surface 44, shown round with it being understood that other shapes are contemplated within the scope of the invention. The irregular inner surface 42 is configured so that the wall thickness at regions 40a of the core member 40 are relatively thinner than regions 40b of the core member 40. More specifically the irregular inner surface is 42 formed as a flattened diamond shape with diverging walls 42a, 42b, 42c, 42d. The walls 42a, 42b join at an apex 42e and the walls 42c, 42d join at an apex 42f The walls 42a and 42c are joined by a curved segment 42g and the walls 42b and 42d are joined by a curved segment 42h. The irregular shape can be varied to produce a desired variation in the thickness of the core wall so that more or less cooling can be produced within the injection molded material directed into a mold cavity 46 formed between the core member 40 and a mold cavity member 48 of known mold apparatus. As a consequence, a preform results that has plastic that will remain hotter in the regions where the core wall thickness is greatest, e.g., at 40b and the plastic will be cooler adjacent the thin wall thicknesses, e.g., at 40a. Such preforms, when processed in a one stage system will remain heated so as to when placed at a blow molding station will be better suited for shaping with uniform all thickness into a non round bottle having a hollow cylindrical shape and a generally oval outline as shown at reference numeral 50 in FIG. 5.

By virtue of the bimetal construction described above, the mold cavity is more effectively cooled at the inlet flow passage of molten material into the mold cavity than if it were to rely solely on cooling provided by a water cooled core assembly of the type shown in the prior art.

What is claimed is:

1. In a mold assembly including spaced, moveable mold parts, one mold part including a hollow cavity having a cavity inner surface configured to form an outer wall of an elongated, generally annular molded part and the other mold part including a corresponding core element having a core outer surface configured to form an inner wall of the molded part, the core element being at least partially disposed within the cavity and the core outer surface spaced from the cavity inner surface defining a generally annular mold chamber for receiving molten material to be molded to the shape of the molded part, the core element having a first portion and a second portion that defines an end portion of the core outer surface; the core element further including a generally tubular core inner surface and a fluid inlet pipe coaxially disposed within the core element, the fluid inlet pipe having a pipe outer surface spaced from the core inner surface, one end of the fluid inlet pipe configured to connect to a source of coolant and a second end of the pipe being in fluid communication with the plurality of coolant passages; said first portion of said core element made from high strength material and configured as a part of the core outer surface and said second portion of said core element formed of improvement comprising: said second portion having an inner surface configuration for improving heat flow from injected plastic material.

2. In the mold assembly of claim 1, said first portion having a tubular planar surface thereon; said second portion including a planar surface thereon generally parallel to said tubular planar surface and engaged with said tubular planar surface; and a bonded connection between said tubular planar surface and said solid planar surface.

3. In the mold assembly of claim 2, said second portion formed from high strength alloy material resistant to impact damage and having greater thermal diffusivity and thermal conductivity than said first portion.

4. In the mold assembly of claim 1, said second portion configured as a solid tip of higher thermal conductivity than the first portion.

5. In the mold assembly of claim 4, said solid tip enclosing said second end of said fluid inlet pipe.

6. In the mold assembly of claim 4, said solid tip being diffusion bonded to said first portion.

7. In the mold assembly of claim 1, said first portion formed of stainless steel and said second portion formed of nickel copper tungsten material.

8. In the mold assembly of claim 2, said first portion formed of stainless steel and said second portion formed of nickel copper tungsten material.

9. In the mold assembly of claim 3, said first portion formed of stainless steel and said second portion formed of nickel copper tungsten material.

10. In the mold assembly of claim 4, said first portion formed of stainless steel and said second portion formed of nickel copper tungsten material.

11. In the mold assembly of claim 1, said second portion having a thermal conductivity in the range of 100-250 W/m/degK.

13. In the mold assembly of claim 1, said core member having an irregular inner surface and a cylindrical outer surface; said irregular inner surface configured to define opposed thin core wall thicknesses and to define opposed thick core wall thicknesses

14. In the mold assembly of claim 13, said irregular inner surface formed with diverging walls; a first pair of said diverging walls joined at a first apex; a second pair of said diverging walls joined at a second apex located opposite said first apex.

15. In the mold assembly of claim 13, said irregular inner surface being diamond shape.

16. A method for improving the performance of a mold assembly including spaced, moveable mold parts, one mold part including a hollow cavity having a cavity inner surface configured to form an outer wall of an elongated, generally annular molded part and the other mold part including a corresponding core element having a core outer surface configured to form an inner wall of the molded part, the core element being at least partially disposed within the cavity and the core outer surface spaced from the cavity inner surface defining a generally annular mold chamber for receiving molten material to be molded to the shape of the molded part, the core element having a first portion and a second portion that defines an end portion of the core outer surface; the core element further including a generally tubular core inner surface and a fluid inlet pipe coaxially disposed within the core element, the fluid inlet pipe having a pipe outer surface spaced from the core inner surface, one end of the fluid inlet pipe configured to connect to a source of coolant and a second end of the pipe being in fluid communication with the plurality of coolant passages, the method including the steps of cutting the end of the first portion of the core element; providing a solid tip of higher thermal conductivity than the first portion and placing it over the heat pipe extension; and bonding an end of the solid tip to the cutoff end of the first portion.
